(19) United States
(12) Patent Application Publication
(10) Pub. No.: US 2013/0324642 A1
(43) Pub. Date: Dec. 5, 2013

(54) CURABLE POLYMER MATERIALS

(71) Applicant: Dieter Rossberg, Froendenberg (DE)

(72) Inventor: Dieter Rossberg, Froendenberg (DE)

(73) Assignee: THYSSENKRUPP UHDE GMBH, Dortmund (DE)

(21) Appl. No.: 14/000,022

(22) PCT Filed: Jan. 25, 2012
(86) PCT No.: PCT/EP2012/000313

§ 371 Date: Aug. 23, 2013

(30) Foreign Application Priority Data
Feb. 17, 2011 (DE) 10 2011 011 609.5

(51) Int. Cl. C08K 7/14; C08K 5/01

(52) U.S. Cl. CPC C08K 7/14; C08K 5/01
USPC 523/465; 264/234

(57) ABSTRACT

A curable compound of a formulation, a method for producing a polymer material from the curable compound, the resulting polymer material, and agents produced from the polymer material.

The invention relates to a curable mass of an inventive formulation, a process for producing a polymeric material from the curable mass, the resulting polymeric material, and items that are manufactured from the polymeric material embodying this invention as well as the use of such items.

Curable masses based on, for example, polyester resin, epoxy resins or polyamide are used for the manufacture of items that are reinforced by fibres, such as glass or textile fibres, and are commonly used by industry. Plastic structures of this kind are materials that consist of reinforcing fibres embedded into a plastics matrix. These are used in a wide variety of fields of application in the form of short-fibre, long-fibre or endless-fibre reinforced components.

The subgroup of glass-fibre reinforced plastics comprises composite materials made of a plastic, such as polyester resin, epoxy resin or polyamide, and glass fibres. Glass-fibre reinforced plastics are standard industrial materials. Tubes or pipes of such kind are DIN standardised and commercially available.

In the field of alkaline fluids, glass-fibre reinforced plastics are predominantly used to hold or transport alkaline liquids. They are usually equipped with a chemically resistant protective coating of a thermoplastic material such as polypropylene. This chemically resistant protective coating is provided on all surfaces that are exposed to alkaline solutions with the aim of protecting the glass-fibre reinforced plastics. This additional protective coating is required in particular if the alkaline solutions reach temperatures of >40° C. which increases their corrosive effect, leading to surfaces being attacked and destroyed.

At temperatures below 40° C. and low alkaline fluid concentrations, there is no need for a thermoplastic, chemically resistant protective coating, the latter being generated instead from the plastic matrix itself.

The disadvantage of the glass-fibre reinforced plastics known in the prior art is that, if the chemically resistant protective coating is damaged, the glass fibres are laid bare and are directly exposed to chemical attack by the fluids of the kind mentioned.

Glass is a highly chemically resistant material but it is not alkali-resistant and is severely attacked and destroyed by alkaline fluids of all kinds. Due to the destruction of the reinforcing fibre the entire composite material is attacked, as the mechanical stability of the composite material is achieved by the reinforcing fibres. The loss of the mechanical stability results in failure of the material as it is not able to resist the pressure and temperature load that prevails, for example, during operation of an industrial plant.

A glass-fibre reinforced plastic tube according to the prior art is known, for example, from DE 10 2008 033 577 A1. This document specifies in particular a plastic tube that demonstrates improved properties with regard to leak tightness, rigidity, form stability and abrasion as compared to the prior art. At the same time the tube wall is formed by at least one centrifuge layer that is manufactured in a centrifuge and/or centrifuge casting process and at least one winding layer that is manufactured in a winding process. Even though such pipes display improved properties, they are very expensive to make.

For environmental reasons it is necessary to develop plastic tubes or pipes of compositions that are of at least reduced metal concentration or do not contain any metal at all. Commonly used metal concentrations according to the state of the art are, for instance, a 6-% cobalt solution in concentrations of 0.5% referred to 100% of a total mass to be cured. The aim of pipes produced from such compositions is to reach lower abrasion rates than state-of-the-art pipes, which will extend the pipe service life. In addition, the aim of a reduced abrasion of pipe materials is to prevent plugging of the pipes by abraded material.

The aim of the present invention is therefore to provide an alternative formulation for a curable mass with reduced metal concentrations or no metal at all, the process for the production of a polymeric material from the curable mass and the polymeric material itself, with the polymeric material showing a lower abrasion rate than conventional polymeric materials when being exposed to alkaline fluids containing chlorine or chlorous compounds in liquid or gaseous physical state. Another aim of the invention is to provide relevant items and uses of the polymeric material.

The aim is achieved by a cobalt-lean curable mass comprising
a resin in the form of epoxy novolac vinyl ester, the resin being contained in a concentration of 96.3 to 98.95%,
a catalyst, the catalyst being contained in the form of a 6-% cobalt solution in a concentration of 0.05 to 0.1%,
an accelerator, the accelerator being contained in the form of dimethylaniline in a concentration of 0 to 0.1%,
a hardener, the hardener being contained in the form of cumol hydroperoxide in a concentration of 1 to 2%,
a UV stabiliser, the UV stabiliser being contained in a concentration of 0 to 0.5%,
paraffin, the paraffin being contained in the form of wax in a concentration of 0 to 1%,
   with the concentration values referring to 100% of a total mass to be cured.

The aim is further achieved by a metal-free formulation according to which the curable mass comprises
a resin in the form of epoxy novolac vinyl ester, the resin being contained in a concentration of 94 to 97.95%,
an accelerator, the accelerator being contained in the form of N,N-dimethylaniline in a concentration of 0.05 to 0.2%,
a hardener, the hardener being contained in the form of dibenzoyl peroxide in a concentration of 2 to 4%,
an inhibitor, the inhibitor being contained in the form of p-tert-butyl catechol in a concentration of 0 to 0.3%,
a UV stabiliser, the UV stabiliser being contained in a concentration of 0 to 0.5%,
paraffin, the paraffin being contained in the form of wax in a concentration of 0 to 1%,
   with the concentration values referring to 100% of a total mass to be cured.

As epoxy novolac vinyl ester resin, DERAKANE MOMENTUM™ 470-300, for example, commercially available from Messrs. Ashland, are used. As accelerator PERGAQUICK A200 or A300, the commercially available product of Messrs. Pergan, can be added. As hardener PEROXAN BP paste 50 or PEROXAN CU-80 L is added, which are also commercially available from Messrs. Pergan. Used as an inhibitor may be the product Pergaslow BK-10, for example. Used as a UV stabiliser may be Tinovin® 5050® of Messrs. Ciba, for example. The wax is BYK®-S 750 of the Altana Group, for example. These products are to be understood as examples and can be substituted by others included in the scope defined according to claim 1 or claim 2.

The process for the production of a polymeric material comprising the curable mass according to claim 1 or 2 comprises the following process steps:
a. submitting resin and catalyst to a pre-acceleration for a period of time that does not exceed the shelf-life of the resin,
b. adding accelerator, hardener, inhibitor, UV stabiliser, paraffin in the given order to generate a curable mass,
c. with one or several constituents of step b) and/or the catalyst from step a) not being applied depending on the formulation,
d. moulding the curable mass into a desired shape using a standard process, thus manufacturing a work piece,
e. optionally applying paraffin to the outside of the work piece, and
f. submitting the work piece to a heat treatment at 80° C. for 8 hours, thus generating a finished polymeric material.

In the case of the inventive metal-free formulation of the curable mass, pre-acceleration is dispensed with by not adding catalyst in step a) of the process according to the invention.

Advantageously further additional components such as fillers and/or fibre materials, especially glass fibres and/or glass non-wovens and/or synthetic non-wovens, are embedded in the curable mass.

Such glass non-wovens are known from the prior art and standardised as well as commercially available as so-called textile glass mats for the reinforcement of plastics. Advantageously they are made of an aluminium borosilicate glass with an alkali mass content of ≦1% of the E glass type or also of alkali lime glasses with increased addition and special chemical resistance of the C glass type.

The invention also relates to a polymeric material comprising the ingredients of the inventive curable mass on the basis of the epoxy novolac vinyl ester resin, with the polymeric material being produced according to the inventive process.

Advantageously further additional components such as fillers and/or fibre materials, especially glass fibres and/or glass non-wovens and/or synthetic non-wovens, are embedded into the polymeric material and give the material its stability.

The polymeric material is preferably resistant to fluids containing chlorine or chlorous compounds in liquid or gaseous physical state, especially to chlorine gas, bleaching lye, anolyte, chlorine-containing exhaust air, moist chlorine and brine condensate. The terminology used is that of the specialist skilled in chlorine-alkali electrolysis engineering. Anolyte, for example, refers to brine with free chlorine gas. Brine condensate refers to a brine solution which also contains chlorine. The polymeric material fulfils this criterion especially at temperatures >60° C. This disclosure refers to chlorous compounds as compounds of the formula R—Cl—X, R standing for an optional reactant and X for the number of chlorine atoms.

Furthermore, the present invention claims items for holding and/or transporting alkaline fluids containing chlorine or chlorous compounds in liquid or gaseous physical state, comprising the inventive polymeric material. Optionally an item of this kind is a tube/pipe or vessel, a pipe of type E or D being used with preference. The maximum glass mass content of pipe type E is 40% and evenly distributed over the circumference. The core layer of this pipe type is made up of a C-glass-non-woven-reinforced resin layer of a thickness of about 0.4 mm. The outer layer of this pipe type is a ply of C-glass or synthetic non-woven and a weather-resistant resin layer of a maximum thickness of 0.2 mm. Pipe type D is characterised by a chemically resistant protective coating of a min. thickness of 2.5 mm and a laminate structure. The chemically resistant protective coating is a resin-rich core layer of a min. thickness of 2.5 mm. It consists of a C-glass non-woven-reinforced pure resin layer, the further structure being made up by textile glass mats made of E glass. The glass mass content in the chemically resistant protective coating ranges between 25 and 30%, getting higher from the inside to the outside. The mass content in the supporting laminate structure is 60±5% and consists of textile glass fabric, textile glass mats and/or textile glass rovings made of E glass. The outer layer is made up by a ply of C-glass or synthetic non-woven and a weather-resistant resin layer of a maximum thickness of 0.2 mm. This information is fully known to the specialist skilled in the art and accessible as it is laid down in DIN 16 965 for pipes.

The pipe class to be advantageously used is favourably pipe class PX or PW. If pipe class PW is selected, glass non-wovens and/or synthetic non-wovens are not used in the area which is exposed to alkaline fluids containing chlorine or chlorous compounds in liquid or gaseous physical state. It was found that such glass non-wovens separate and plug piping if exposed to alkaline fluids such as chlorine gas, bleaching lye, anolyte, chlorine-containing exhaust air, moist chlorine and brine condensate. The specialist skilled in the art is familiar with the pipe class designations PX and PW. Pipe class PX is rated for a temperature of up to and including 80° C., whereas pipe class PW is rated for a temperature of up to and including 95° C.

In a preferred embodiment of the invention the item for holding and/or transporting alkaline fluids containing chlorine or chlorous compounds in liquid of gaseous physical state can be connected by a filler compound comprising the ingredients of the inventive curable mass on the basis of the carrier material pyrogenic silicic acid.

Advantageously the invention is mainly used in devices of processes in which alkaline fluids containing chlorine or chlorous compounds in liquid or gaseous physical state are added and/or used.

Preferably the invention is used in devices and/or piping and/or process vessel engineering of a chlorine plant in which alkaline fluids containing chlorine or chlorous compounds in liquid or gaseous physical state are produced and/or added.

In another application of the inventive polymeric material, the devices are the devices of an electrolysis process in which alkaline fluids containing chlorine or chlorous compounds in liquid or gaseous physical state are produced and/or added.

The invention is illustrated in detail below by means of two exemplary embodiments by way of example. These examples cover studies on abrasion rates of polymeric materials exposed to the flow of alkaline fluids containing chlorine or chlorous compounds in liquid or gaseous physical state.

An inventive pipe material and a state-of-the-art pipe material were exposed to the flow of an anolyte solution, i.e. brine, loaded with free chlorine gas, for a period of more than four years. The detailed composition of the pipe materials is shown in the following table:

TABLE 1
Composition of the pipe materials analysed

| | Inventive polymeric | | State-of-the-art | |
|---|---|---|---|---|
| | material | | polymeric material | |
| Resin | Epoxy novolac | 96.3% | HET acid | 80% |
| | vinyl ester | | neopentyl glycol | |
| Catalyst | 6-% cobalt | 0.1% | 1-% cobalt | 1.5% |
| | solution | | solution | |
| Solvent | — | 0% | Styrene | 15% |
| Accelerator | Dimethylaniline | 0.1% | — | 0% |
| Hardener | Cumol | 2% | Acetyl acetone | 1.5% |
| | hydroperoxide | | peroxide | |
| Inhibitor | | 0% | p-tert-butyl | 0.5% |
| | | | catechol | |
| UV stabiliser | UV protection | 0.5% | UV protection | 0.5% |
| Paraffin | Wax | 1% | Wax | 1% |

At intervals of approximately one year the pipe thickness was determined at different measuring points (total of 8) and the resulting mean value. The results are shown in the following tables:

TABLE 2
Abrasion rates with an exposure of the inventive polymeric
material to anolyte solution, i.e. brine, loaded with free
chlorine gas, over approximately 4 years.
Inventive polymeric material

| | 03.07.06 | 23.10.07 | 24.09.08 | 09.06.09 | 09.06.10 | |
|---|---|---|---|---|---|---|
| | Original wall | Abrasion 1 | Abrasion 2 | Abrasion 3 | Abrasion 4 | Original |
| Measuring point | mm | mm | mm | mm | mm | to abrasion 4 |
| 1 | 9.5 | 10.0 | 10.3 | v | 9.7 | — |
| 2 | 9.6 | 9.5 | 9.3 | 9.3 | 9.3 | 97% |
| 3 | 10.0 | 9.8 | 9.6 | 9.6 | 8.8 | 88% |
| 4 | 10.0 | 10.0 | 10.0 | 9.7 | 9.2 | 92% |
| 5 | 9.8 | 9.6 | 9.3 | v | 8.2 | 84% |
| 6 | 9.8 | 9.5 | 9.3 | 9.3 | 8.9 | 91% |
| 7 | 10.3 | 10.1 | 9.6 | 9.8 | 9.2 | 89% |
| 8 | 9.7 | 9.5 | 9.4 | 9.2 | 8.7 | 90% |
| | 9.8 | 9.8 | 9.6 | 9.5 | 9.0 | 91% |
| | | | −0.2 | −0.1 | −0.5 | −0.8 |

TABLE 3
Abrasion rates with an exposure of the state-of-the-art polymeric material to
anolyte solution, i.e. brine loaded with free chlorine gas, over approximately 4 years
State-of-the-art polymeric material

| | 03.07.06 | 23.10.07 | 24.09.08 | 09.06.09 | 09.06.10 | Original |
|---|---|---|---|---|---|---|
| | Original wall | Abrasion 1 | Abrasion 2 | Abrasion 3 | Abrasion 4 | to |
| Measuring point | mm | mm | mm | mm | mm | abrasion 4 |
| 1 | 7.4 | 7.0 | 6.4 | v | 5.9 | 80% |
| 2 | 7.9 | 7.6 | 6.8 | v | v | — |
| 3 | 7.6 | 7.0 | 6.7 | 6.5 | 5.5 | 72% |
| 4 | 7.6 | 7.3 | 6.6 | 6.4 | 5.4 | 71% |
| 5 | 7.7 | 7.3 | 6.4 | 6.0 | 5.2 | 68% |
| 6 | 8.4 | 7.8 | 7.2 | 6.8 | 5.8 | 69% |
| 7 | 7.6 | 7.3 | 6.6 | 6.4 | 5.3 | 70% |
| 8 | 7.5 | 7.2 | 6.8 | 6.5 | 5.4 | 72% |
| | 7.7 | 7.3 | 6.7 | 6.4 | 5.5 | 71% |
| | | −0.4 | −0.6 | −0.3 | −0.9 | −2.2 |

As can be seen from tables 2 and 3, the state-of-the-art polymeric material was abraded by 2.2 mm on an average over a period of approx. four years, whereas the inventive polymeric material was abraded by only 0.8 mm on an average. This corresponds to an abrasion of 9% over four years in the case of the inventive polymeric material and an abrasion of 29% over 4 years in the case of the state-of-the-art polymeric material. With the inventive composite material it was thus possible to significantly minimise the abrasion rate thanks to the use of the inventive polymeric material.

In another experiment, a pipe type E of pipe class PW was used consistently, with the composition of the analysed pipe materials being shown in table 4. To be mentioned especially is the use of different resins as a basis.

TABLE 4
Composition of the pipe materials analysed

| | Ingredients in % of | | | | | | | | | | | | | |
|---|---|---|---|---|---|---|---|---|---|---|---|---|---|---|
| | total mass to be cured | | | | | | | | | | | | | |
| | Sample | 1 | 2 | 3 | 4 | 5 | 6 | 7 | 8 | 9 | 10 | 11 | 12 | 13 |
| A | Unsaturated HET acid | 94.1 | | | | | | | | | | | | |
| | polyester | | | | | | | | | | | | | |
| | Bromated vinyl ester | | 95.7 | 95.6 | | | | | | | | | | |
| | Novolac vinyl ester | | | | 95.7 | | | | | | | | | |
| | Epoxy novolac vinyl | | | | | 95.8 | | | | | | | | |
| | ester, bromated | | | | | | | | | | | | | |
| | Epoxy novolac vinyl | | | | | | 95.8 | 96.3 | | | | | | |
| | ester | | | | | | | | | | | | | |
| | Bisphenol A, unsaturated | | | | | | | | 95.7 | | | | | |
| | polyester | | | | | | | | | | | | | |
| | Bisphenol A urethane | | | | | | | | | 96.2 | | | | |
| | vinyl ester | | | | | | | | | | | | | |
| | Bisphenol A urethane | | | | | | | | | | 95.7 | | | |
| | vinyl ester, modified | | | | | | | | | | | | | |
| | HET acid/neopentyl | | | | | | | | | | | 95.9 | 94% | 80% |
| | glycol | | | | | | | | | | | | | |
| B | 6-% cobalt solution | 0.5 | 0.5 | 0.5 | 0.5 | 0.5 | 0.5 | 0.1 | 0.5 | 0.5 | 0.5 | 0.5 | | |
| | 1-% cobalt solution | | | | | | | | | | | | | 1.5 |
| C | Dimethylaniline | 0.1 | | 0.1 | | 0.1 | 0.1 | 0.1 | | | | 0.1 | | |
| | N,N-dimethylaniline | | | | | | | | | | | | 0.2 | |
| D | Acetyl acetone | | | | | | | | | | | | | 1.5 |
| | peroxide | | | | | | | | | | | | | |
| | Cumol hydroperoxide | | | | | | | 2.0 | | | | 2.0 | | |
| | Dibenzoyl peroxide | | | | | | | | | | | | 4.0 | |
| | Methyl ethyl ketone | 3.5 | 2.0 | 2.0 | 2.0 | 2.0 | 2.0 | | 2.0 | 1.5 | 2.0 | | | |
| | peroxides | | | | | | | | | | | | | |
| E | Acetyl acetones | | | | | 0.1 | | | | | | | | |
| | 2,4-pentanediones | | | | | | 0.1 | | | | | | | |
| | p-tert-butyl catechol | 0.3 | 0.3 | 0.3 | 0.3 | | | | 0.3 | 0.3 | 0.3 | | 0.3 | 0.5 |
| F | UV protection | 0.5 | 0.5 | 0.5 | 0.5 | 0.5 | 0.5 | 0.5 | 0.5 | 0.5 | 0.5 | 0.5 | 0.5 | 0.5 |
| G | Wax | 1.0 | 1.0 | 1.0 | | | 1.0 | 1.0 | 1.0 | 1.0 | 1.0 | 1.0 | 1.0 | 1.0 |
| H | Styrene | | | | | | | | | | | | | 15.0 |

A = resin,
B = catalyst,
C = accelerator,
D = hardener,
E = inhibitor,
F = UV stabiliser,
G = paraffin,
H = solvent

Tinovin® 5050® of Messrs. Ciba was used for UV protection in all pipes and BYK-S 750 of the Atlana Group was used as a wax in all cases.

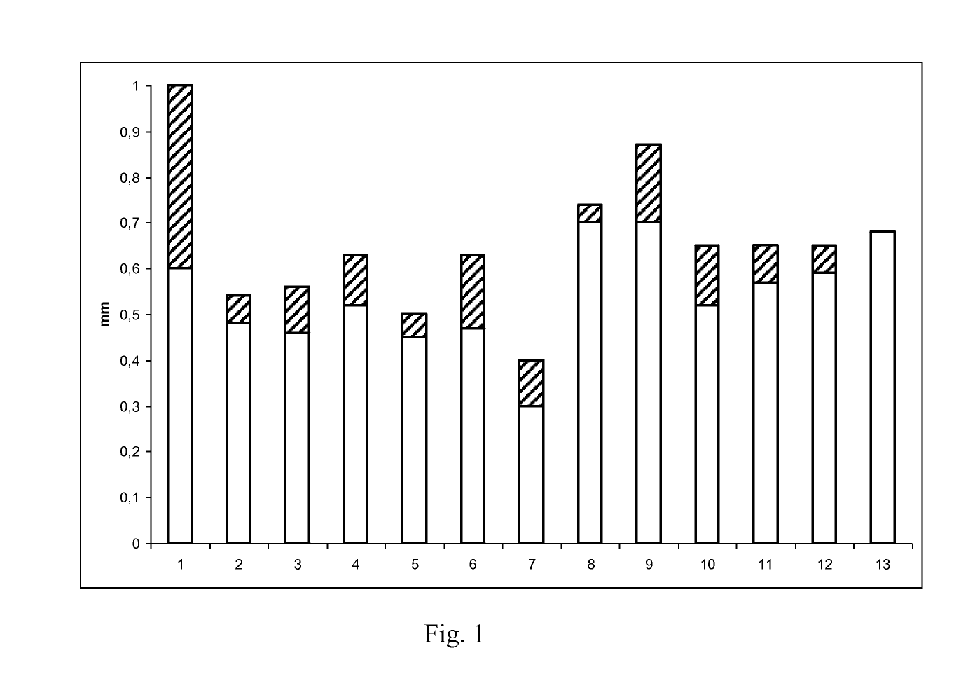

In the case of this long-term experiment of four years an anolyte solution was likewise sent through the piping (samples 1-13) and the abrasion over this period measured. The result is shown in FIG. 1. The bars without criss-cross lines show the mean abrasion rate in mm over a period of four years, whereas the criss-crossed bars show the maximum abrasion rate determined by means of an individual value measured. It is apparent that sample 7 which is the inventive composition in metal-lean formulation has by far the lowest abrasion rate. The metal-free formulation is represented by sample 12 which gives somewhat better results than sample 13, which is based on the same resin but has a formulation according to the state of the art. Sample 12 shows results comparable to sample 11 which also has cobalt concentrations in accordance with concentrations according to the state of the art. These experiments clearly show that the fine adjustment of the composition is decisive for generating a polymeric material of low abrasion rate and, in addition, of little to no metal content.

Advantages involved in the invention:

High resistance of polymeric material to alkaline fluids containing chlorine or chlorous compounds in liquid or gaseous physical state, with reduced abrasion rate over the time.

Resistance of polymeric material in the presence of alkaline fluids containing chlorine or chlorous compounds in liquid or gaseous physical state even at high temperatures.

Extended service life of polymeric material on account of reduced abrasion.

Reduced plugging of respective piping by abraded products owing to lower abrasion rate.

Worldwide availability of all ingredients in the curable mass.

1. Use of a polymeric material comprising the ingredients of the following curable masses:
a resin in the form of epoxy novolac vinyl ester, the resin being contained in a concentration of 96.3 to 98.95%,
a catalyst, the catalyst being contained in the form of a 6-% cobalt solution in a concentration of 0.05 to 0.1%,
an accelerator, the accelerator being contained in the form of dimethylaniline in a concentration of 0 to 0.1%,
a hardener, the hardener being contained in the form of cumol hydroperoxide in a concentration of 1 to 2%,
a UV stabiliser, the UV stabiliser being contained in a concentration of 0 to 0.5%,
paraffin, the paraffin being contained in the form of wax in a concentration of 0 to 1%,
with the concentration values referring to 100% of a total mass to be cured
or
a resin in the form of epoxy novolac vinyl ester, the resin being contained in a concentration of 94 to 97.95%,
an accelerator, the accelerator being contained in the form of N,N-dimethylaniline in a concentration of 0.05 to 0.2%,
a hardener, the hardener being contained in the form of dibenzoyl peroxide in a concentration of 2 to 4%,
an inhibitor, the inhibitor being contained in the form of p-tert-butyl catechol in a concentration of 0 to 0.3%,
a UV stabiliser, the UV stabiliser being contained in a concentration of 0 to 0.5%,
paraffin, the paraffin being contained in the form of wax in a concentration of 0 to 1%,
with the concentration values referring to 100% of a total mass to be cured,
in devices of an electrolysis process in which alkaline fluids containing chlorine or chlorous compounds in liquid or gaseous physical state are produced and/or added.

2. Use of a polymeric material according to claim 1, wherein further additional components such as fillers and/or fibre materials, especially glass fibres and/or glass non-wovens and/or synthetic non-wovens, are embedded in the polymeric material.

3. Use of a polymeric material according to claim 1, wherein the polymeric material is produced in a process comprising the following process steps:
a. submitting resin and catalyst to a pre-acceleration for a period of time that does not exceed the shelf-life of the resin,
b. adding accelerator, hardener, inhibitor, UV stabiliser, in the given order to generate a curable mass,
c. with one or several constituents of step b) and/or the catalyst from step a) not being applied depending on the formulation,
d. moulding the curable mass into a desired shape using a standard process, thus producing a work piece,
e. optionally applying paraffin to the outside of the work piece, and submitting the work piece to a heat treatment at 80° C. for 8 hours, thus generating a finished polymeric material.
